(19) United States
(12) Patent Application Publication
(10) Pub. No.: US 2007/0209241 A1
(43) Pub. Date: Sep. 13, 2007

(54) Earthmoving device

(75) Inventors: Frank L. Corrado, Kennett Square, PA (US); Frank H. Robinson JR., Clayton, DE (US); William W. Wipf, Bear, DE (US); Joseph J. Corrado, New Castle, DE (US)

Correspondence Address: CONNOLLY BOVE LODGE & HUTZ, LLP, P O BOX 2207, WILMINGTON, DE, 19899, US

(73) Assignee: Corrado American, Inc., New Castle, DE (US)

(21) Appl. No.: 11/368,194

(22) Filed: Mar. 3, 2006

(51) Int. Cl. B65G 15/30

(52) U.S. Cl. 37/389

(57) ABSTRACT

The present invention relates to a device for scraping material from the earth. The device has a scraper housing, which may be attached to the front of a bulldozer or other earthmoving vehicle. The scraper housing may generally include a back wall, a first side wall, a second side wall, a center support wall, and a brace. The device may be equipped with a scraper blade attached to an earth transfer plate, the scraper blade attached proximate to the front of the scraper housing. As the scraper housing is urged forward, the scraper blade scrapes material from the earth which, by the force of the material being scraped, is forced along the earth transfer plate. After reaching the end of the earth transfer plate, the material can be deposited onto a scraper conveyor that has a belt extending between the side walls of the housing. The scraper conveyor belt continuously moves material toward an opening in the second wall. The device may also include a boom conveyor extending from an outside portion of the second side wall of the scraper housing and located below the opening in the second side wall to catch material conveyed past the edge of the scraper conveyor belt to carry the material to a distant location. For example the boom conveyor may be positioned over a truck so that material is continuously moved from the scraper housing to the truck for transportation and dumping. The boom conveyor may be supported by an adjustable support member.

### BACKGROUND OF THE INVENTION

The present invention relates generally to earthmoving equipment. Earthmoving equipment is typically used for excavating, pushing, and/or transporting large quantities of earth. Some examples of earthmoving equipment include bulldozers, track or wheel front end loaders, backhoes, and wheel tractor-scrapers. More particularly, the invention relates to a device that can be attached to conventional earthmoving equipment to enhance its material scraping and transportation abilities.

In earthmoving, the goals are to move material quickly and economically. Typically to increase the speed of removal requires a higher investment cost in more expensive equipment. For example, a piece of specialized heavy equipment, similar to the wheel-tractor scraper disclosed in U.S. Pat. No. 6,276,077, is used to remove and transport large amounts of earth. The wheel tractor-scraper has a rear portion with a vertically moveable hopper that has a sharp horizontal front edge. The hopper can be hydraulically lowered and raised. In the lowered position, the front edge of the hopper “cuts” into the soil, which is then collected into the hopper as the scraper advances along its path. When the hopper is filled, it can be closed with a vertical blade and the tractor-scraper is driven to a desired location, typically called a “fill” area, where the contents are dumped. Scrapers can be very efficient on short hauls where the cut and fill areas are close together and have a scraping area of sufficient length to fill the hopper. One disadvantage of wheeled tractor-scrapers is that they are large, expensive machines that are highly specialized solely for the purpose of scraping and dumping. Furthermore, the operator must cease scraping to dump the contents of the hopper.

Another disadvantage of such devices is their weight, especially when loaded. That weight can cause severe problems when operating in certain soil conditions, more particularly the weight of the device can break through the soil surface. That, in turn, can mire the device in loose soil and prevent effective scraping.

Other prior material removal devices, such as the continuous excavating machine disclosed in U.S. Pat. No. 4,616,880 (Nozaki et al.), comprise a scraper that is pulled or pushed along the ground to collect material and force it onto a conveyor belt. The conveyor belt transfers the material to a desired location or dump truck for transporting to a more distant location. The primary disadvantage of this type of scraper is that, like the tractor-scraper, a user must purchase a separate piece of relatively large and expensive equipment to scrape and remove material from the earth.

Bulldozers, loaders and other types of relatively common earthmoving equipment can also be used to remove and transport earth or other material. A bulldozer is a conventional device, as described, for example, in U.S. Patent Application Publication 2005/0126055, and is a tracked vehicle equipped with a large thick metal plate, typically called a blade, attached on its front end. As the machine is driven forward, the blade scrapes, pushes and relocates earthen material. A similar machine called a loader, also known as a front loader, front end loader, bucket loader, scoop loader or shovel, is a type of wheeled or tracked vehicle that, like a bulldozer, can scrape and push material, but also has arms and a rotatable bucket that lift and move material into, for example, a truck. Loaders and bulldozers may be provided with linkage and hydraulic couplers that allow the user to replace the bucket or plate with other tools.

Bulldozer and loaders are advantageous in that they are more versatile, more readily available, and may be relatively less expensive compared to tractor-scrapers and specialized excavator equipment. However, these vehicles are typically relatively limited in the amount of material that they can remove. For example, bulldozers are typically limited to pushing material around and are unable to load material on a truck for more distant dumping. Although a front end loader or other bucket style device can lift dirt to a dump truck or other transportation means, the removal process advances relatively slowly because the operator must periodically stop scraping in order to dump the contents of the bucket. Furthermore, a loader bucket can usually store only about 3-5 cubic yards of earthen material before it must be emptied.

It is therefore an objective of the present invention to provide a device that will allow for the quick and efficient scraping and removal of dirt or other earthen material. It is further an objective of the present invention to adapt the scraping and removing device for attachment to a standard and versatile piece of equipment such as a bulldozer or front-end loader. It is still further an objective of the invention that the scraper attachment be capable of simultaneously scraping the earth and moving material along a boom conveyor to move the material to another location, such as a truck.

The following disclosure describes a novel earthmoving device that can be attached to standard earthmoving equipment and that overcomes the deficiencies of the prior art.

### BRIEF SUMMARY OF THE INVENTION

In order to achieve the above mentioned objectives the invention provides an attachment for the front of earthmoving equipment, such as a bulldozer or front end loader. More particularly, the invention may include a scraper housing with a back wall, a first side wall, a second side wall including an opening through a portion of the second side wall. A scraper blade for scraping material may be located proximate the front the scraper. An earth transfer plate may be attached to the scraper blade for directing material from the scraper blade to a scraper conveyor. The scraper conveyor may be conveyor belt for continuously moving material in a direction toward the second side wall and positioned so that a top surface of the scraper conveyor belt lies below at least one edge of the earth transfer plate for catching material as it is scraped and collected.

The invention may also comprise a boom conveyor attached to and extending from an outside portion of the second side wall of the scraper housing and located below the opening in the second side wall to catch material conveyed past the edge of the scraper conveyor belt, the boom conveyor further comprising a belt oriented to carry the material away from the scraper housing.

### BRIEF DESCRIPTION OF THE DRAWINGS

Novel features and advantages of the present invention in addition to those noted above will become apparent to persons of ordinary skill in the art from a reading of the following detailed description in conjunction with the accompanying drawings wherein similar reference characters refer to similar parts and in which:

FIG. 1 is a front elevational view of an earth moving scraper attachment to a vehicle such as a bulldozer, the attachment having a conveyor system for discharging excavated material;

FIG. 2 is a side elevational view of FIG. 1;

FIG. 3 is a top elevational view of FIGS. 1 and 2;

FIG. 4 is bottom plan view of the scraper housing shown in FIGS. 1-3; and

FIG. 5 is a cross-sectional view in elevation taken along line 5-5 of FIG. 3.

### DETAILED DESCRIPTION OF EMBODIMENTS OF THE INVENTION

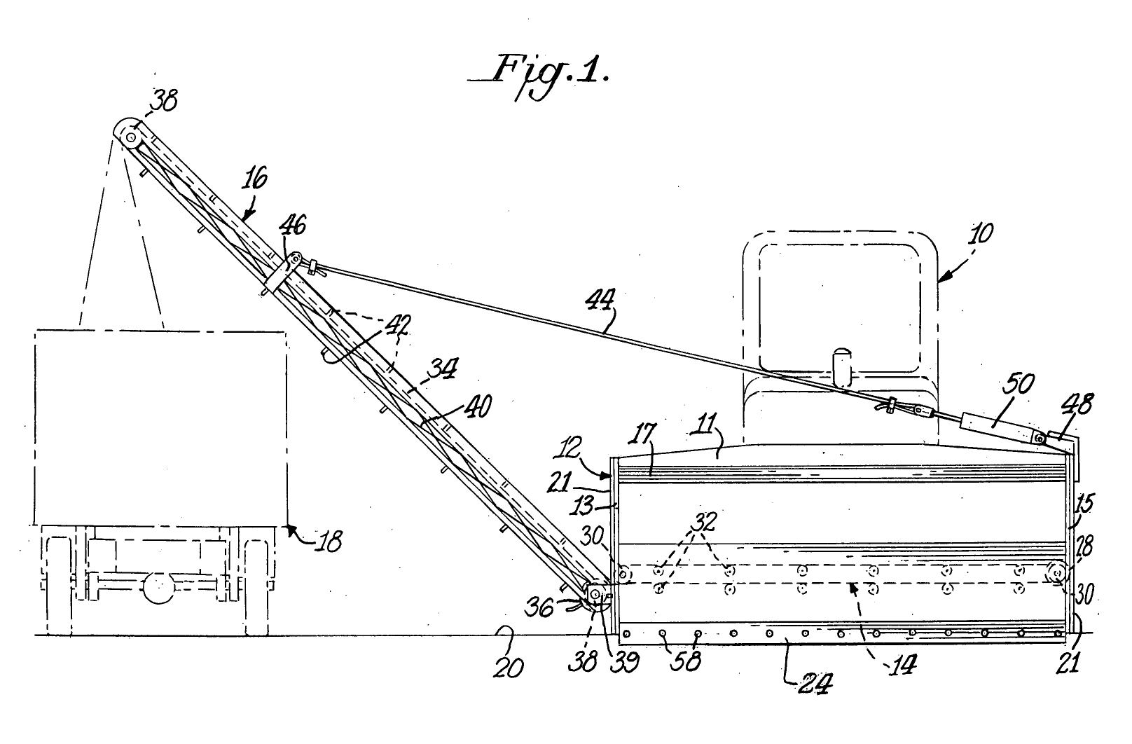

A preferred embodiment of the scraping device according the present invention will now be described in detail with reference to FIGS. 1-5.

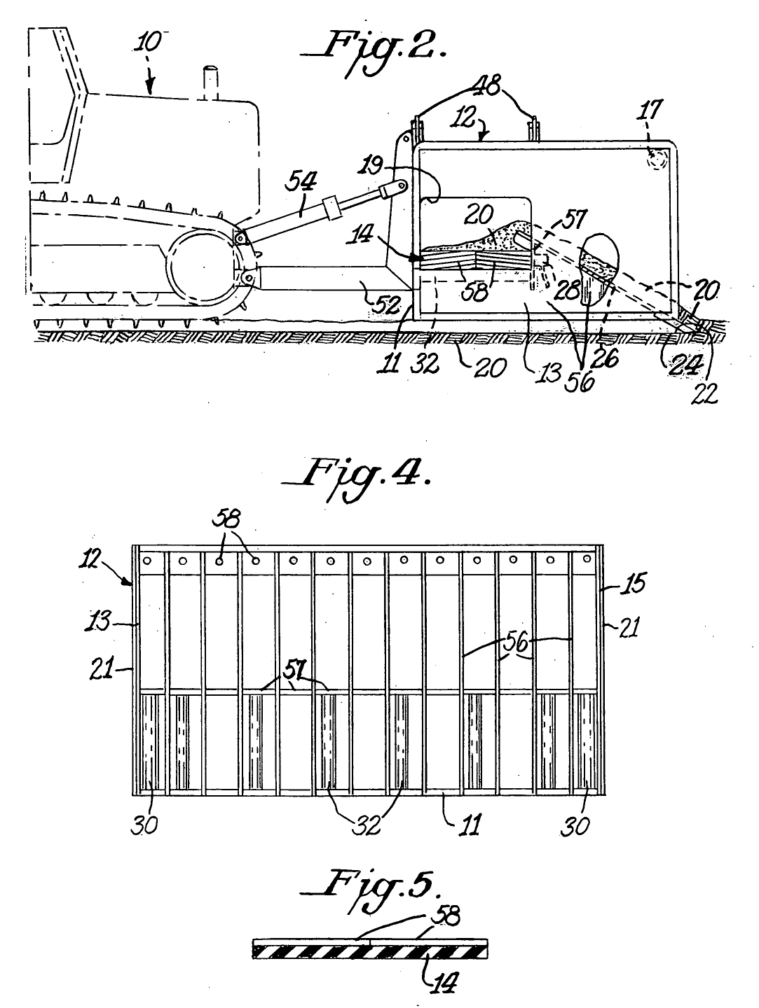

FIG. 1 shows a front elevational view of the present invention. By way of example, a bulldozer 10 or other suitable vehicle is connected to and drives scraper housing 12, which is designed to scrape earthen material 20 and collect it within scraper housing 12 (see FIG. 2). Scraper housing 12 may be provided with scraper conveyor belt 14 for transporting material from within scraper housing 12 to boom conveyor 16. Material 20 is then carried along boom conveyor 16 until it is discharged away from scraper housing 12. For example, the material may be discharged from the boom conveyor 16 into a truck 18.

The scraper housing 12 may be generally box-shaped and may include a rear wall 11 and side walls 13 and 15, shown in FIGS. 1 through 3. The scraper housing may be constructed of steel or other suitable material and the walls may be approximately one inch thick. The scraper housing may be approximately twelve feet wide, approximately seven feet deep (i.e. from rear wall 11 to the front edge of scraper blade 24), and approximately five feet tall. Although scraper housing 12 may be provided with top, bottom, or front walls (not shown), preferably the scraper housing does not have these elements. Instead, brace 17, which may be comprised of steel tubing, may provide structural support between side walls 13 and 15 (see FIGS. 1, 2). A reinforcement frame 21 of, for example, one inch thick steel may be provided around the perimeter of scraper housing 12 for additional structural support. The scraper housing 12 may be maintained within the reinforcement frame 21, by any suitable means including, but not limited to, gravity assisted contact, securing devices such as nut and bolt configurations (not shown), or welding at one or more points along frame 21. The scraper housing 12 and reinforcement frame 21 may be integral. Other details of scraper housing 12 will be provided below with particular reference to its operation.

FIG. 2 shows a side elevational view of scraper housing 12 and illustrates how it is attached to bulldozer 10. A bracket 52, which may be L-shaped, may be utilized to connect the bulldozer 10 to frame 21, or to scraper housing 12 at back wall 11, or to both the frame 21 and scraper housing 12. The connection may be accomplished using any conventional linkage mechanism. A hydraulic cylinder 54 may also be attached between the bulldozer 10 and scraper housing 12 to allow the operator to raise, lower, and/or tilt scraper housing 12. Bracket 52 may be the arms conventionally used for mounting the original bulldozer blade.

As shown in FIG. 2, when an operator (not shown) drives bulldozer 10 forward, the scraper housing 12 is pushed along the earth 22 with the scraper blade 24 impinging into the earth 22 a depth of, for example, approximately 6″ to 12″. As scraper housing 12 is advanced forward, earthen material 20 is scraped from the surface of the earth 22 and collected within scraper housing 12. More particularly, as scraper blade 24 digs into earth 22, earthen material 20 is gathered and forced onto and along earth transfer plate 26 by virtue of the force of the earthen material 20 being scraped and collected. Upon being pushed beyond the edge of earth transfer plate 26, earthen material 20 is then deposited onto scraper conveyor belt 14. The scraper blade may extend, for example, approximately two inches from the bottom of the scraper housing 12.

The earth transfer plate 26 and scraper blade 24 may be placed at an angle of, for example, 20 to 60 degrees with respect to the bottom of scraper housing 12. Preferably, the earth transfer plate 26 and scraper blade 24 are oriented at an angle of 30 degrees with respect to the scraper housing 12. Earth transfer plate 26 may be of any suitable material of any suitable thickness. For example, earth transfer plate 26 may be a one inch thick steel. Blade 24 may also be constructed of hardened steel and may have a tapered end to enhance the scraping function. Blade 24 may extend approximately two inches below the bottom of scraper housing 12.

As mentioned above, material 20 is deposited from the earth transfer plate 26 onto the scraper conveyor belt 14. Scraper belt 14 may be comprised of metal, rubber, plastic, fabric, or other suitable material and may be driven by one or more motors 28. The motor(s) 28 may be powered by a separate power supply located on the rear of the vehicle 10. Alternatively, the motors 28 may be hydraulic and may be connected to the hydraulic system of the bulldozer 10. Belt 14 may be supported by rollers 30 located proximate to side wall 13 and side wall 15 of scraper 12. Additional, and potentially smaller, rollers 32 may also be placed under belt 14 to provide additional support. Rollers 30 and 32 may comprise bearings (not shown) that are mounted on rods (not shown) as is conventional in the arts of roller and conveyor belt technologies. Rollers 30 and 32 may be attached to scraper housing 12 at the back wall 11 and at center support member 57 to provide support to scraper belt 14. Center support member 57 may be attached to side wall 13 and side wall 15 and may provide support to the earth transfer plate 26. Alternatively or additionally, center support member 57 may be attached to and supported by one or more lateral cross-members 56. Motor 28 turns belt 14 and advances material 20 toward opening 19 provided in side wall 13 which is aligned with boom conveyor 16, as shown in FIG. 3.

As belt 14 turns, material 20 is eventually deposited onto boom conveyor 16. Boom conveyor is attached to side wall 13 at brackets 39 using any conventional means, such as, for example, a bolt and nut configuration. Boom conveyor 16 comprises a belt 34 that may be driven by a motor 36. Boom conveyor 16 may also be provided with rollers 38 at each end to allow belt 34 to rotate more freely. Rollers 38 may comprise bearings (not shown) that are mounted on rods (not shown) as is conventional in the art and described with respect to rollers 30 and 32 above. Support structure 40 may be provided between rollers 38 to provide structural support for belt 34. Belt 34 may also be provided with raised slats 42 to improve the transportation of material 20 along boom conveyor 16.

Boom 16 may be supported by one or more boom support members 44, which each may comprise a cable, wire, rod or other suitable means of support. An anchor bracket 46 or other attachment means may be provided to attach support member 44 to boom 16. Support member 44 may be attached to scraper housing 12 with mounting bracket 48. Support member 44 may further be provided with an adjustor 50 to permit a user to raise and lower boom 16. Adjustor 50 may be manual or power-assisted with a hydraulic cylinder or other suitable power means. If the adjustor 50 is a hydraulic cylinder as show in FIGS. 1 and 3, the adjustor may be connected to the hydraulic system of the bulldozer 10. A hydraulic powered or manual winch (not shown) may be used as adjustor 50 rather than hydraulic cylinder 50 shown. Boom 16 may be provided with a suitable length and angle to efficiently advance and discharge material 20 into a truck 18, which may have a height of, for example, 10-13 feet.

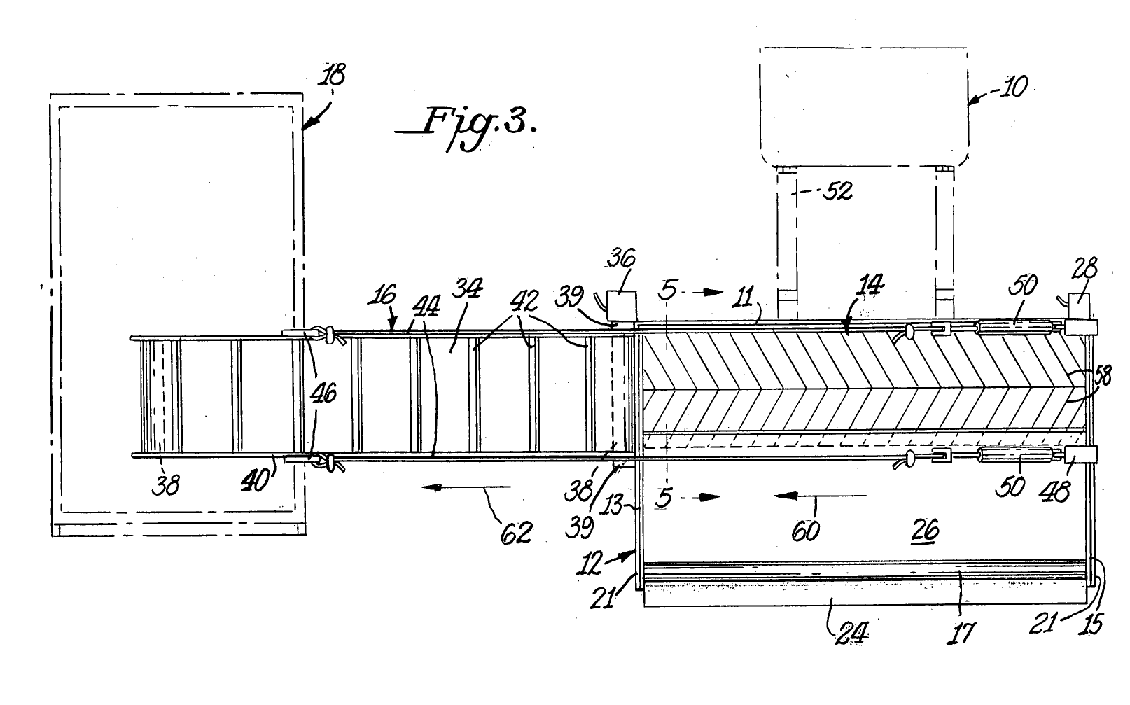

As shown in FIG. 4, the bottom of scraper housing 12 may be generally open, but may comprise lateral cross members 56, which may extend to and provide support for blade 24, earth transfer plate 26, center support member 57 and back wall 11. Adjacent cross members 56 may be spaced apart by, for example, approximately twelve inches. As FIG. 4 also shows, blade 24 may be secured to earth transfer plate 26 by bolts 58 or other suitable securing means. Transfer plate 26 may be welded to cross members 56. Bolts 58, or other suitable attaching means, may be used to attach replaceable cutting edge 24.

As shown in FIG. 5, conveyor belt 14 may be provided with chevron or V-shaped raised portions 58. The chevron or V-shape is preferably oriented as shown in FIG. 3 so that the center of the V-shape follows the ends of the V-shape in the direction of travel, which are illustrated for belts 14 and 16 by arrows 60 and 62, respectively. The V-shaped pattern assists in urging material 20 toward opening 19 and preventing material slippage.

The foregoing description of the invention illustrates and describes the present invention. Additionally, the disclosure shows and describes only the preferred embodiments of the invention, but it is to be understood that the invention is capable of use in various other combinations, modifications, and environments and is capable of changes or modifications within the scope of the inventive concept as expressed herein, commensurate with the above teachings, and/or the skill or knowledge in the art of equipment manufacture. Accordingly, the description is not intended to limit the invention to the form disclosed herein. Also, it is intended that the appended claims be construed to include alternative embodiments.

What is claimed is:

1. A device for scraping material comprising:
a scraper housing comprising a back wall, a first side wall, a second side wall including an opening through a portion thereof, a scraper blade for scraping material, an earth transfer plate attached to the scraper blade for conveying material from the scraper blade to a scraper conveyor, and a scraper conveyor comprising at least two rollers aligned between the first and second side walls and the scraper conveyor further comprising a belt positioned on the rollers to provide a surface for continuously moving material in a direction toward the opening in second side wall and positioned so that a top surface of the scraper conveyor belt lies below at least one edge of the earth transfer plate for catching material scraped by the scraper blade and conveyed past the edge of earth transfer plate and advancing that scraped material toward the opening in second side wall; and
a boom conveyor attached to and extending from an outside portion of the second side wall of the scraper housing and located below the opening in the second side wall to catch material conveyed past the edge of the scraper conveyor belt, the boom conveyor further comprising a belt oriented to carry the material away from the scraper housing, the boom conveyor including a support member.

2. The device according to claim 1 adapted for attachment to earthmoving equipment.

3. The device according to claim 2, wherein the earthmoving equipment is a bulldozer.

4. The device according to claim 2, wherein the earthmoving equipment is a tractor.

5. The device according to claim 1, wherein the scraper conveyor is powered by a motor.

6. The device according to claim 1, wherein the support member is attached to the boom conveyor and to the first wall.

7. The device according to claim 6, wherein the support member has an adjustor for adjusting the angle at which the boom conveyor extends from the second wall.

8. The device according to claim 7, wherein the adjustor for adjusting the angle of the boom conveyor is a winch or hydraulic cylinder.

9. The device according to claim 1 further comprising a reinforcement frame to reinforce the scraper housing.

10. The device according to claim 1, wherein the scraper blade extends below the scraper housing.

11. The device according to claim 1, wherein the scraper conveyor belt has chevron shaped raised portions.

12. An earthmoving attachment comprising:
a scraper housing comprising a scraper blade, earth transfer plate, and scraper conveyor belt positioned below an edge of the earth transfer plate to provide a surface for continuously moving material from the earth transfer plate toward an opening in the scraper housing; and
a boom conveyor attached to and extending from an outside portion of the scraper housing and located below the opening in the scraper housing to catch the material conveyed past the edge of the scraper housing and to convey the material away from the scraper housing.

13. The attachment according to claim 12, adapted for attachment to earthmoving equipment.

14. The attachment according to claim 12, wherein the attachment is attached to a bulldozer.

15. The attachment according to claim 12, wherein the attachment is attached to a tractor.

16. The attachment according to claim 12, further comprising a reinforcement frame to provide additional support to the scraper housing.

17. The attachment according to claim 12, wherein the scraper blade extends below the scraper housing.

18. The attachment according to claim 12, wherein the scraper conveyor belt has chevron shaped raised portions.

19. The attachment according to claim 12, further comprising a support member for supporting the boom conveyor, the support member attached to the boom conveyor and to the scraper housing and including an adjustor for adjusting the angle at which the boom conveyor extends from the second wall.

20. The attachment according to claim 12, wherein the adjustor for adjusting the angle of the boom conveyor is a winch or hydraulic cylinder.
